(19) United States
(12) Patent Application Publication
(10) Pub. No.: US 2026/0208134 A1
(43) Pub. Date: Jul. 23, 2026

(54) VISCOSITY MONITORING FOR INDUSTRIAL FOOD PROCESSING

(71) Applicant: D C Norris & Company Ltd., Great Gransden (GB)

(72) Inventor: David Alan Norris, Great Gransden (GB)

(73) Assignee: D C Norris & Company Ltd., Great Gransden (GB)

(21) Appl. No.: 19/240,157

(22) Filed: Jun. 17, 2025

(30) Foreign Application Priority Data
Jan. 21, 2025 (GB) 2500842.6

(51) Int. Cl. B01F 35/21; B01F 35/90; B01F 101/06

(52) U.S. Cl. CPC B01F 35/2136; B01F 35/90; B01F 2035/99; B01F 2101/06

(57) ABSTRACT

An industrial food processing system comprises a vessel for containing a flowable food product, and an agitator positioned within the vessel. A rotatable element is mounted to a drive shaft of the agitator, so as to rotate within the food product in the vessel. A static element is also positioned within the vessel adjacent a path of the rotatable element. A load sensor is coupled to the static element and/or to the rotatable element, and rotation of the rotatable element relative to the static element within the food product causes a load detectable by the load sensor proportional to a viscosity of the food product as the elements pass one another.

### CROSS-REFERENCE TO RELATED APPLICATION(S)

This application claims priority to and the benefit of United Kingdom Application No. 2500842.6, entitled “VISCOSITY MONITORING FOR INDUSTRIAL FOOD PROCESSING,” filed Jan. 21, 2025, incorporated herein by reference.

### TECHNICAL FIELD

The present invention concerns the monitoring of the viscosity of a flowable food product in industrial food processing.

### BACKGROUND

Flowable food products are foods that can be moved by pumping, and include liquid food products, as well as semi-solid food products. Examples include soups, stews, sauces, dressing, curries, pie fillings, and the like. Flowable food products may include some solids, such as chunks of meat or vegetable.

During industrial production of flowable food products, it is common practice to check the viscosity of a prepared food product against a reference viscosity measurement before approving the food product for further processing or distribution.

### SUMMARY

Viewed from a first aspect, the present invention provides a food processing system, comprising: a vessel for containing a flowable food product; a rotatable element configured for rotation within the food product in the vessel; a static element configured to be positioned within the food product in the vessel and adjacent a path of the rotatable element; and a load sensor coupled to the static element and/or to the rotatable element, wherein the rotatable element and the static element are configured such that rotation of the rotatable element within the food product will create a load detectable by the load sensor corresponding to a viscosity of the food product.

The passage of the rotatable element past the static element within the food product causes a detectable force, which is proportional to the viscosity of the food product. Thus, the viscosity of the food product can be tested without needing to remove a sample from the vessel. Additionally, the process can be more highly automated, thereby reducing the risk of operator error.

The food processing system may comprise an agitator, which may be configured for rotation within the vessel, e.g. for mixing the food product. The rotatable element may be coupled to the agitator, and particularly to a drive shaft of the agitator.

The food processing system may comprise a probe. The probe may comprise the static element and an arm. The static element may be coupled to the arm, and the arm may be configured to extend into the flowable food product in the vessel.

The load sensor may be coupled to an end of the arm opposition the static element (i.e., an end of the arm opposite to an end to which the static element is coupled). Alternatively, the load sensor may be incorporated within the arm or may be provided between the arm and the static element.

The load sensor may comprise a strain gauge.

The probe may be controllably deployable into the vessel and/or may be controllably removable from the vessel. For example, the system may comprise a motor configured actuate the arm, such as by axially extending and/or retracting the probe, or to pivotally swinging the arm.

The food processing system may comprise a display screen and a controller. The controller may be configured to calculate a viscosity of the flowable food product based on a load measured by the load sensor. The display screen may be configured to display the calculated viscosity. The calculated viscosity may be displayed as a Bostwick viscosity value.

The food processing system may comprise means for heating the flowable food product in the vessel. The means may comprise a steam infusion spear. The steam infusion spear may be configured to extend into the vessel. The means may additionally, or alternatively, comprise a steam chamber, for example surrounding at least a part of the vessel and configured to heat the at least part of the vessel.

The vessel may have a capacity of at least 50 litres, such as between 50 litres and 5,000 litres.

The static element and the rotatable element may be configured to be, in use, separated at their closest position by a distance. The distance may be at least 5 mm, or at least 8 mm. The distance may be less than 25 mm, or less than 20 mm, or less than 15 mm. The static element and the rotatable element may be configured to create a gap of substantially consistent width at their closest position. The gap may comprise a length of at least 10 mm, or at least 20 mm.

Viewed from a second aspect, the present invention provides a method of monitoring a flowable food product in a vessel of a food processing system, the method comprising: rotating a rotatable element within the food product in the vessel, wherein a static element is positioned within the food product in the vessel adjacent a path of the rotatable element; and monitoring a load detected by a load sensor coupled to the static element and/or to the rotatable element, wherein the rotatable element and the static element are configured such that rotation of the rotatable element within the food product will create a load detectable by the load sensor corresponding to a viscosity of the food product.

The food processing system may be as described above in the first aspect, optionally including any of the optional features thereof.

The rotatable element may be coupled to an agitator of the food processing system, and the rotatable element may be rotated by actuation of the agitator.

A probe may comprise the static element coupled to an arm, and the method may further comprise deploying the probe into the vessel.

The method may comprise calculating a viscosity of the flowable food product based on a load measured by the load sensor, and displaying the viscosity on a display screen of the food processing system. The displayed viscosity may be a Bostwick viscosity value.

The rotating element may be rotated, for example during a viscosity sensing operation, at a rate of at least 5 revolutions per minute. The monitoring may comprise monitoring the load detected by a load sensor over a period of time, such as at least 10 seconds, or at least 30 seconds, or at least one minute. The monitoring may comprise taking an average value of a plurality of readings over the period.

Viewed from a third aspect, the present invention provides a method of installing a viscosity sensor in a food processing system, comprising a vessel for containing a flowable food product; and an agitator configured for rotation within the vessel, the method comprising: installing a rotatable element on the agitator, or replacing the agitator with an agitator comprising a rotatable element mounted thereto; installing a static element in the system so as to be positioned within vessel adjacent a path of the rotatable element; and installing a load sensor in the system, the load sensor being coupled to the static element and/or to the rotatable element, wherein the rotatable element and the static element are installed such that rotation of the rotatable element within the food product, in use, will create a load detectable by the load sensor corresponding to a viscosity of the food product.

Thus, in some embodiments, the invention provides a method of retrofitting means for sensing viscosity into an existing food processing system. The resulting food processing system may be a food processing system as described in the first aspect, optionally including any of the optional features thereof.

Aspects can include one or more features to address one or more of the following potential issues that may be present using other techniques.

A viscosity measurement that deviates from the reference viscosity measurement may indicate that the food product has not been sufficiently processed (e.g. cooked), or has been over-processed. It may also indicate other problems with the production of the food product, such as spoiled ingredient, an error in the quantities of one or more ingredient, or malfunctioning food processing equipment.

Today, viscosity measurement in commercial food production is carried out using a consistometer, most commonly a Bostwick consistometer. A Bostwick consistometer is an instrument comprising sloped steel trough with graduation markings. A sample of food product to be tested is filled into a reservoir behind a spring-loaded gate. The gate is opened and the food product is allowed to flow for along the graduated trough for a period of time, commonly 30 seconds. The distance travelled by the food product is then recorded as a Bostwick viscosity value.

This process has been used for many years. However, it can be prone to operator error. The Bostwick consistometer must be perfectly level when the food product is tested, and the temperature of both the equipment and the food product can affect the flow rate of the food product. Additionally, an operator must manually time the test, and then visually identify the viscosity measurement from the graduations.

In addition to the risk of error, the test requires a sample of the food product to be taken, which necessitates stopping and opening of the processing equipment. Also, some time is required to set up the equipment, collect the sample and conduct the test itself. This makes the taking of a viscosity measurement using a Bostwick consistometer inconvenient, and consequently this testing is typically only performed as the final stage of the food processing operation. That is, viscosity measurements are not normally taken at an intermediate stage of the food processing operation, for example to guide the process.

Some embodiments provide an improved technique for measuring the viscosity of a flowable food product.

### BRIEF DESCRIPTION OF THE DRAWINGS

Certain exemplary embodiments of the invention will now be described in greater detail, by way of example only and with reference to the accompanying drawings, in which:

FIG. 1 shows a cut-away view of a food processing system; and

FIG. 2 shows a cross-sectional view of a vessel of the food processing system.

### BRIEF DESCRIPTION

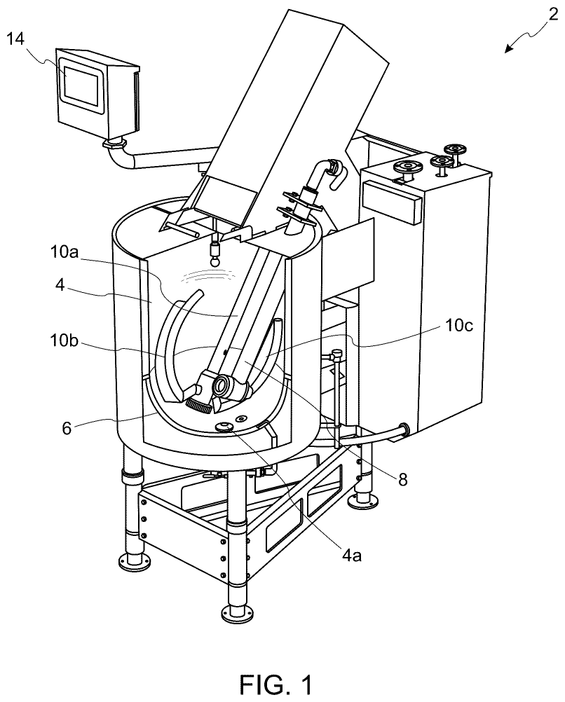

FIG. 1 shows an industrial food processing system 2 for processing a flowable food product. In the illustrated example, the food processing system 2 is a steam-jacketed, agitated kettle cooker. However, the present invention is applicable to other types of food processing system 2.

The food processing system 2 comprises a vessel 4 for holding the flowable food product during the food processing operation. Typically, for industrial food processing equipment, the vessel might 4 have a capacity between 50 litres and 5,000 litres, with the illustrated example being about 500 litres.

The vessel 4 is made of stainless steel and the lower part of the vessel 4 is surrounded by a steam chamber 6, such that the lower walls of the vessel 4 are heated during operation of the food processing system 2.

The lowermost point of the vessel 4 is provided with a drop-down valve to allow the flowable food product to be removed from the vessel 4, and in turn the food processing system 2, under the effects of gravity, optionally assisted with a pump (not shown).

The food processing system 2 comprises a steam infusion spear 8 extending into the vessel 4. The steam infusion spear 8 is configured to inject pressurised steam into the food product. This both cooks and moves the flowable food product within the vessel 4. Further details of an exemplary steam infusion spear 8 can be found in GB 2490000 A.

The food processing system 2 comprises an agitator 10 configured within the vessel 4 for mixing the flowable food product. The agitator 10 comprises a drive shaft 10a and a pair of blades 10b, 10c configured for rotation within the vessel 4. The blades 10b, 10c may each comprise one or more scraper configured to move close to, or against, the interior walls of the vessel 4.

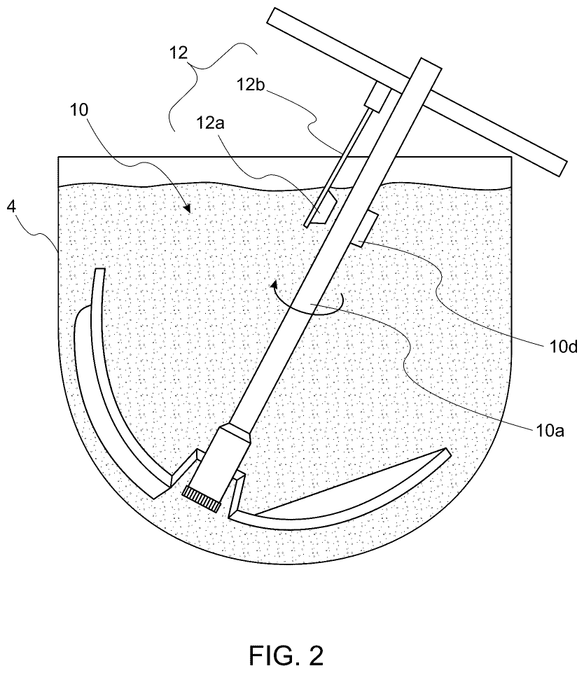

Referring now to FIG. 2, a schematic cross-section of the vessel 4 and agitator 10 is shown, which illustrates an arrangement of components permitting viscosity measurement to be taken for the flowable food product within the vessel 4.

A rotatable element 10d is mounted to the agitator 10, and particularly to the dive shaft 10a of the agitator 10. The rotatable element 10d is configured to rotate with the agitator 10, and takes the form of a plate or flag.

The food processing system 2 further comprises a probe 12. The probe 12 comprises a static element 12a configured to remain substantially stationary within the vessel 4 during a viscosity sensing operation. The static element 12a likewise takes the form of a plate or flag.

The probe 12 is configured to position the static element 12a proximate the rotatable element 10d, such that passage of the rotatable element 10d through the food product and past the static element 12a causes the food product to apply a load to the static element 12a.

In one example, the rotatable element 10d and the static element 12a are spaced apart by approximately 10 mm.

In the illustrated embodiment, the probe 12 is configured to extend into the flowable food product within the vessel 4, from the top of the vessel 4. The probe 12 thus comprises an arm 12b connected to the static element 12a that extends into the vessel 4.

The probe 12 further comprises, or is connected to, a load sensor (not shown). The load sensor may take any form suitable for detecting a load applied to the static element 12a. For example, the load sensor may comprise a strain gauge.

In one embodiment, the load sensor may be connected to an end of the arm 12b of the probe 12, opposite to the static element 12a, i.e. outside of the food product. The load sensor may be configured to detect a torsional load applied about an axis of the arm 12b, or a lateral load applied perpendicular to the axis of the arm 12b.

In other embodiments, the load sensor might be incorporated within the arm 12b itself, or may be located at a joint between the static element 12a and the arm 12b.

In yet further embodiments, the load sensor might instead be coupled to the rotatable element 10d.

The rotation of the rotatable element 10d within the flowable food product with cause movement of the food product, which will in turn apply a load to the static element 12a. The magnitude of the load is based on the viscosity of the food product, which a higher viscosity resulting in a greater load applied to the static element 12a as the rotatable element 10d passes.

The probe 12 is configured such that it may be controllably deployed into the vessel 4, such as when it is desired to conduct a viscosity sensing operation. The probe 12 may likewise be controllably withdrawn from the food product, for example to protect the probe 12 from damage that could occur under particular processing conditions.

In some embodiments, the probe 12 may be configured to be positioned at different depths into the vessel 4, for example to allow viscosity measurements to be taken when different quantities of flowable food product are present within the vessel 4, or to take viscosity measurements at different depths within the flowable food product. Thus, the system 2 may comprise a plurality of rotatable elements 10d, or an elongate rotatable element 10d, or a vertically-positionable rotatable element 10d.

An exemplary food processing operation using the food processing system 2 comprises the following steps.
1. Fresh ingredients are prepared and weighed according to a standardised recipe.
2. The prepared ingredients are transferred to the food processing system 2 in tote bins or buckets.
3. The ingredients are added in stages into the food processing system 2, as per the standardised recipe.
4. The food processing system 2 is operated to supply steam the steam chamber 6 and to the steam injection spear 8, and to actuate the agitator 10, in accordance with the standardised recipe, so as to produce a flowable food product.
5. A viscosity sensing operation is performed to determine a viscosity of the flowable food product.
6. When the cooking cycle is complete and the viscosity of the flowable food product matched a reference viscosity, the drop-down valve 4a of the vessel 4 is opened allow the food product to be pumped out of the food processing apparatus for packaging.

An exemplary viscosity sensing operation using the food processing system 2 comprises the following steps.
1. The probe 12 is deployed into the flowable food product.
2. The rotatable element 10 d is rotated, for example by operation of the agitator 10, at a predetermined rotational speed.
3. A load is applied to the static element 12 a of the probe by the rotatable element 10 d via the flowable food product, whereby the load is detected by the load sensor of the probe 12.

The peak load measured by the load sensor as the rotatable element 10d passes the static element 12a is proportional to the viscosity of the flowable food stuff. Thus, by monitoring this load, the viscosity of the flowable food stuff can be determined.

It will be appreciated that the monitored load will periodically pulsate as the rotatable element 10d passes the static element 12a. The peak load value of each pulse may be used to calculate the viscosity of the food product at that time.

Various data sanitization techniques may be applied to the raw load data before using the load value to calculate the viscosity. For example, the raw load data may be low-pass filtered to remove noise. Additionally, several load data values may be taken across each pulse, which may be averaged or where high/low values are discarded in order to derive the load value to be used.

In some embodiments, an average of the peak load value for two or more pulses may be used. For example, the viscosity may be calculated based on an average of the peak load values taken over a predetermined period of time, such as one minute (e.g. 27 pulses, in the case of the agitator 10 rotating at 27 rpm). Where continuous viscosity measurements are provided to an operator, a rolling average or a decaying average may be used.

In some embodiments, the monitored load may be converted to a viscosity value, which may for example be displayed on a display screen 14 of the food processing system 2. The can inform an operator of the food processing system 2, and allow them to compare the viscosity to a reference viscosity value.

It will be appreciated that similar data sanitation techniques to those discussed above may also be applied to the viscosity values in addition to, or instead of, applying them to the raw load data.

Conversion of the measured load to a Bostwick viscosity value, for example by a controller (not shown) of the system 2, may be useful to provide backwards compatibility with existing recipes. However, any unit of viscosity may be displayed, particularly where new recipes are created and the unit used for the reference viscosity of that recipe may be freely selected.

A reference viscosity value will typically be given for a food product at a specific temperature. The food processing system 2 may comprise a temperature sensor (not shown), and a temperature of the flowable food product may additionally be shown on the display screen 14.

In other embodiments, either in addition to or as an alternate to displaying the viscosity on the display screen 14, the load measured by the load sensor may be supplied to a controller (not shown) of the food processing system 2. This may be used as a data input for controlling the food processing operation. For example, the measured viscosity (or load value) and a reference viscosity (or load value) may be used to determine how long to continue application of steam heating to the food product.

Measuring of the viscosity of the flowable food in this manner is advantageous for a number of reasons.

Firstly, the viscosity can be measured continuously without disturbing the food processing operation, or at least with minimum disruption (e.g. merely changing a rotational speed of the agitator 12). For example, where the rotatable element 12d is mounted to the agitator drive shaft 12a, a viscosity value is generated each time the agitator 12 makes a rotation. In one example, the agitator 12 operates at 27 revolutions per minute, although other rates are of course possible.

This can provide substantially real-time viscosity data to an operator of the food processing system 2, or to the food processing system 2 itself. Such data can be useful for ensuring that a desired viscosity is achieved, and for determining when to conclude a food processing operation, such as cooking.

Additionally, this technique allows for the measurement of viscosity to be automated by the food processing system 2. This reduces the involvement of a human operator in the measurement operation, thereby reducing the risk of operator error when determining a viscosity measurement. Consequently, greater consistency of food product can be achieved by virtue of being able to achieve greater consistency of viscosity measurement.

Advantageously, this means for measuring viscosity can be easily retrofitted into existing food processing systems 2.

That is to say, a rotatable element can be either mounted to the drive shaft 10a of an existing agitator 10, or alternatively either drive shaft 10 or the entire agitator 10 maybe replaced by one including a rotatable element 10d, and a probe 12 and load sensor may be installed in the system 2.

What is claimed is:

1. A food processing system, comprising:
a vessel for containing a flowable food product;
a rotatable element configured for rotation within the food product in the vessel;
a static element configured to be positioned within the food product in the vessel and adjacent a path of the rotatable element; and
a load sensor coupled to the static element and/or to the rotatable element,
wherein the rotatable element and the static element are configured such that rotation of the rotatable element within the food product will create a load detectable by the load sensor corresponding to a viscosity of the food product.

2. The food processing system according to claim 1, comprising:
an agitator, wherein the rotatable element is coupled to the agitator.

3. The food processing system according to claim 1, comprising:
a probe comprising the static element and an arm, wherein the static element is coupled to the arm, and the arm is configured to extend into the flowable food product in the vessel.

4. The food processing system according to claim 3, wherein the load sensor is coupled to an end of the arm opposite to an end to which the static element is coupled.

5. The food processing system according to claim 3, wherein the probe is controllably deployable into the vessel and controllably removable from the vessel.

6. The food processing system according to claim 1, comprising:
a display screen,
wherein a controller of the food processing system is configured to calculate a viscosity of the flowable food product based on a load measured by the load sensor, and to display the viscosity on the display screen.

7. The food processing system according to claim 6, wherein the calculated viscosity is displayed as a Bostwick viscosity value.

8. The food processing system according to claim 1, comprising:
a heating element configured for heating the flowable food product in the vessel, the heating element comprising a steam infusion spear.

9. The food processing system according to claim 1, wherein the vessel has a capacity of between 50 litres and 5,000 litres.

10. A method of monitoring a flowable food product in a vessel of a food processing system, the method comprising:
rotating a rotatable element within the food product in the vessel, wherein a static element is positioned within the food product in the vessel adjacent a path of the rotatable element; and
monitoring a load detected by a load sensor coupled to the static element and/or to the rotatable element,
wherein the rotatable element and the static element are configured such that rotation of the rotatable element within the food product will create a load detectable by the load sensor corresponding to a viscosity of the food product.

11. The method according to claim 10, wherein the rotatable element is coupled to an agitator of the food processing system, and the rotatable element is rotated by actuation of the agitator.

12. The method according to claim 10, wherein a probe comprises the static element coupled to an arm, the method further comprising:
deploying the probe into the vessel.

13. The method according to claim 10, comprising:
calculating a viscosity of the flowable food product based on a load measured by the load sensor, and
displaying the viscosity on a display screen of the food processing system.

14. The method according to claim 13, wherein the displayed viscosity is a Bostwick viscosity value.

15. The method according to claim 10, wherein the rotating element is rotated at a rate of at least 5 revolutions per minute, and the monitoring comprises monitoring the load detected by a load sensor over a period of at least one minute.

16. A method of installing a viscosity sensor in a food processing system, comprising a vessel for containing a flowable food product; and an agitator configured for rotation within the vessel, the method comprising:
installing a rotatable element on the agitator, or replacing the agitator with an agitator comprising a rotatable element mounted thereto;
installing a static element in the system so as to be positioned within vessel adjacent a path of the rotatable element; and
installing a load sensor in the system, the load sensor being coupled to the static element and/or to the rotatable element,
wherein the rotatable element and the static element are installed such that rotation of the rotatable element within the food product, in use, will create a load detectable by the load sensor corresponding to a viscosity of the food product.
